(19) United States
(12) Patent Application Publication
(10) Pub. No.: US 2024/0257485 A1
(43) Pub. Date: Aug. 1, 2024

(54) SYSTEM AND METHOD FOR VIRTUAL GARMENT FITTING

(71) Applicants: Katie To, Burnaby (CA); Kiet Vo, Burnaby (CA)

(72) Inventors: Katie To, Burnaby (CA); Kiet Vo, Burnaby (CA)

(21) Appl. No.: 18/160,889

(22) Filed: Jan. 27, 2023

(51) Int. Cl. G06T 19/20; G06T 7/90; H04N 5/265

(52) U.S. Cl. CPC G06T 19/20; G06T 7/90; H04N 5/265; G06T 2207/10024; G06T 2219/2024

(57) ABSTRACT

A virtual garment fitting method uses a database comprising scale-standardized wearer avatar models of bodies of wearers and clothing overlay models of sized clothing articles. Each mathematical model is based on a single side-captured image of the clothing article on a mannequin, and the body of the wearer. The system graphically renders overlaid clothing overlay models onto the avatar models—the standardized image capture position and scale of the base images result in maximized perspective congruence and accuracy between clothing and wearers in the rendered fitting image.

This invention is in the field of ecommerce methods for sales of clothing items and more specifically relates to a system for the virtual fitting of mathematically generated graphic models of clothing articles onto a simulated body model of a purchaser.

### BACKGROUND

As ecommerce merchandise sales and vendors have proliferated, one industry which has seen exponential growth is the online sales of clothing articles. Many different online shopping cart and sales systems have been developed for the offer for sale of clothing items to the public without retail stores.

Clothing is the most popular item purchased online anywhere in the world, despite serious challenges in the industry in customer satisfaction and service. Primary issues for customer service and satisfaction in this industry e-commerce sales are clothing purchases that turn out to be the wrong size because the differences in sizing measurement categories between brands, design variables from online pictures to the real thing, and the lack of knowledge by consumers of the materials used in the clothing manufacturing process. Research even suggests that retailers do a disservice to themselves in this area because they fail to offer consistent sizes across their own product ranges, while shapes and sizes of various garments vary enormously between retailers.

Most of these problems persist online because most people when shopping online choose their clothing based on an image instead of being able to actually try on consequently, the products received often result in a poor fit and customer disappointment. The number one reason given by shoppers for returning clothing is the variation in measurement which determines sizing.

To facilitate customers trying on clothing articles, most ecommerce vendors need to include a robust exchange and return function in their business to accept product returns or size exchanges. Processing exchange and return transactions is costly for ecommerce clothing vendors and any type of an approach which will moderate the number of exchange or return transactions that need to be processed, for example by providing the ability for purchasers to most accurately virtually assess their clothing selection in advance of purchase, would be accepted in the marketplace.

As online clothing sales sites have developed, many vendors use different types of “virtual fitting room” software, which is software allowing the clothing purchaser to view and assess clothing articles virtually on a simulated body avatar of themselves. Many of the early stages attempts at virtual fitting rooms simply allowed purchasers to select a body type from a group of graphic body types presented, and perhaps to choose skin color, hair length and color or the like, to provide at least an albeit artificial model of a body to show clothing articles on before purchase. At the extreme opposite end of the complexity spectrum, attempts have been made at virtual fitting room technology relying upon full three-dimensional body scans of the purchaser being conducted with advanced and expensive scanning equipment-requiring the customer or the vendor to typically incur a substantial cost to capture a scan of their body. Yet further options have involved development of entire new garment sizing systems, requiring significant supply chain and garment system modifications for clothing manufacturers to accommodate. It would be preferable to provide a virtual fitting system which relied on pre-existing garment sizing and physical mannequin infrastructure rather than requiring the use of new or different hardware to assist in the generation of the overlays of clothing articles, to minimize complexity and cost for vendors. Providing the ability for cross vendor compatibility and congruency in images displayed and virtual fitting technology would be significant in the industry.

Additional issues in virtual fitting room technology have resulted from the fact that often if a wearer avatar is generated of the purchaser separately from already wearing the clothing article, the avatar of the body is not rendered at the same scale as the overlay/skin of the clothing article which is created-if it were possible to create these articles at or near the same physical scale, they would match most accurately and provide the most accurate virtual fitting experience.

If it were possible to provide a method of generating the most accurate possible models of the bodies of purchasers, along with clothing articles themselves, for juxtaposition on each other and providing the most accurate graphic “virtual fitting room experience”, using readily available equipment and technology for purchasers and vendors, it is believed that this would be virtual fitting room approach which would be widely and easily marketable.

### SUMMARY OF THE INVENTION

One of the objects of the present invention is to provide a virtual garment fitting method for displaying images of simulated graphical models of clothing articles on the body of a wearer using scale-standardized models of the clothing articles and the body of the wearer.

A further object of the present invention is to provide a virtual garment fitting method for displaying images of simulated graphical models of clothing articles on the body of a wearer which uses pre-existing garment sizing scales and equipment to generate the graphical models of the clothing articles for use.

A further object of the present invention is to provide a virtual garment fitting method for displaying images of simulated graphical models of clothing articles on the body of a wearer which uses basic and pre-existing data capture equipment and methods to capture the necessary data to render the human body avatars and sized graphic clothing overlays, without the need for three-dimensional scanning of the clothing articles or the body of the wearer.

The present invention comprises a virtual garment fitting method for displaying images of simulated graphical models of clothing articles on the body of a wearer using scale-standardized models of the clothing articles and the body of the wearer. The method relies upon a server. The server typically comprises a processor and memory, and a network interface for communication with user client devices each having a user interface. The user client devices will typically be internet-connected smart devices or remote computers of potential clothing vendors and purchasers. Details of the server hardware will be understood to those skilled in the art and are all contemplated within the scope of the present invention, as are the various types of user client devices.

The server of the present invention hosts a fitting software component for executing the steps of the method. The fitting software component will comprise any combination of locally stored or locally accessible processor instructions for execution on the server in conjunction with its hardware components and in communication with networked client devices to aid the execution of the virtual fitting method as further outlined herein.

In addition to the fitting software component, the server will also host or have access to a wearer database containing wearer records each corresponding to a clothing wearer. Each wearer record will store the necessary information of a clothing shopper/wearer to assist in the use of the present method-many different database structures will be understood to those skilled in the art along with many different types of wearer data which could be stored in a wearer record. Each wearer record will store at least the identification of the wearer, and a wearer avatar model being a mathematical model permitting the graphic rendering of a three-dimensional wearer avatar on the video display of a user device. The wearer avatar model is generated based upon a single captured wearer image being a photo image of the body of the wearer captured from the side of the wearer from a standardized location and in a standardized scale. The wearer record will, in addition to the data comprising the wearer avatar model, also store a wearer size value corresponding to the clothing size of the wearer in a standard applicable pre-existing scale of clothing sizes (several scales might exist in the market—for example based on geographic location or otherwise, and at least one such size could be stored. The wearer record could also include multiple wearer size values where multiple clothing scales exist and are to be used in accordance with the remainder of the present invention—adaptation of the system and method of the present invention to accommodate different wearer size values for different pre-existing clothing size scales will also be understood to those skilled in the art and are intended to be captured within the scope hereof).

In addition to the wearer database, the server would also host or have access to a clothing database containing a plurality of clothing records each corresponding to a clothing article in a particular manufactured size. Each clothing record will contain the necessary data with respect to a particular size of a particular clothing article, permitting the rendering of the particular article and size combination onto the avatar of a wearer. The clothing record would at least contain in respect of the clothing article details of the clothing article which might be used in a virtual fitting room or ecommerce system—product name, color choices, etc.—along with a clothing size value corresponding to the manufactured size of the clothing article in the pre-existing standardized garment size scale [matching the size scale used in the wearer records]. The clothing record would also include a clothing overlay model being a mathematical model permitting the graphic rendering of a three-dimensional overlay of the clothing article onto a wearer avatar on the video display of a user device. The clothing overlay model is generated based upon a single captured clothing image being a photo image of the physical clothing article on a standard-sized mannequin corresponding to the clothing size value, captured from the side of the mannequin from a standardized location and in a standardized scale. Visual details of the garment would also be stored to permit the coloring or patterning of the rendered clothing overlay on the avatar of the wearer to provide the most accurate and fulsome fitting experience—i.e., details of fabric patterns, colors etc. which would permit the proper rendering of color or pattern on the combination of the clothing overlay and the wearer avatar. The clothing records could contain additional information as well as will be understood to those skilled in the art without departing from the intended scope of the present application.

The method comprises using the server and the fitting software component to execute certain steps as required. For example, a person wishing to use the system as a wearer could, using a client device in communication with the server, initiate a wearer creation request. On receipt of a wearer creation request, the fitting software component would execute the necessary steps to create a wearer record corresponding to the person, executing a wearer record creation subroutine to create a wearer record.

Similar to the creation of wearer records, a clothing vendor or manufacturer could initiate a request to the server for creation of a clothing record in accordance with the invention-on receipt of a clothing creation request from a user client device, the server and software component could execute a clothing record creation subroutine to create a clothing record corresponding to a particular size of a particular physical garment for use in the remainder of the fitting method in the clothing database.

The fitting software component can then execute virtual fitting requests based on wearer and clothing records stored. On receipt of a virtual fitting request from a client device in respect of and containing details corresponding to a wearer and a clothing article to be fitted the fitting software component could execute a fitting rendering step by first selecting a corresponding wearer record from the wearer database, being the selected wearer record, and selecting at least one clothing record from the clothing database corresponding to the clothing article to be fitted, by matching the wearer size value from the corresponding wearer record against the clothing size value for clothing records corresponding to the clothing article, being the selected clothing records. In certain cases a single clothing record with matching size values could be offered for selection or selected, and in other cases the system might for example select a matching size record along with sizes up and down to provide different views of similarly or closely sized versions of the clothing article in question to allow the wearer to visually assess the fit of different close sizes of the article. Both such approaches and necessary method and system modifications are understood to be within the scope of the present invention.

Following the selection of at least one selected clothing record, corresponding to a particular size of a clothing article, the fitting software component will generate a combined fitted avatar model in respect of each selected clothing record, being a mathematical model combining the wearer avatar model of the selected wearer record with the clothing overlay model of the selected clothing record. The combined fitted avatar model will then be transmitted/rendered for display on the video display of a user device of the wearer, for a three-dimensional simulated view capable of manipulation of the clothing article on the body of the wearer.

The standardized image capture position and scale of the single wearer image and the single clothing image used to generate the avatar model and clothing overlay model combined in the fitting rendering step result in maximized perspective congruence between said models and maximized accuracy in the rendered fitting image.

The system of the present invention permitting for virtual fitting could be integrated into a freestanding e-commerce system, providing the ability for purchasers to virtually try on the garments of one or more sizes to view them in advance of purchase and thus the integration could also facilitate a shopping cart function etc. where purchases could be facilitated through the vendor website. Alternatively, the system and method of the present invention could also be modified to include the necessary shopping cart functionality to internally facilitate product sales. Both such approaches are contemplated within the scope of the present invention.

As will be understood by those skilled in the art of database design and software design, many different wearer record creation subroutine workflows could be created within the scope and intention of the present invention. For example, in some embodiments, the first step of the wearer record creation subroutine would comprise a data capture step consisting of serving a data capture interface to the user client device originating the wearer creation request permitting the entry of wearer details. The wearer details which would be captured by such an interface would include the identification of the wearer, a wearer size value corresponding to the clothing size of the wearer on the standard clothing sizing scale used in the remainder of the method, as well as a single wearer image being a photo image of the body of the wearer captured from the side of the wearer from a standardized location and in a standardized scale. The system and software the present invention could provide aids for the proper capture of the single wearer image from the desired standardized location and in the standardized scale, for example providing a graphical overlay for use in conjunction with a built-in camera in a mobile or smart device etc., indicating the proper location from which such an image should be captured.

The server would then receive the completed and transmitted wearer details from the user client device and using the single wearer image contained therein would generate a wearer avatar model. The wearer avatar model is a mathematical model by which a three-dimensional rendering of the body of the wearer could be created for subsequent use and user interaction in the remainder of the method. Various types of mathematical modelling approaches could be used for this purpose. Effectively by using a single side view image of the body of the wearer, the wearer avatar model when completed would effectively comprise the data required to render a view of the body of the wearer which could properly show the fit or draping of a clothing article when applied thereto in a particular size.

Following the generation of the wearer avatar model, the server and software component could then create and store a corresponding wearer record in the wearer database.

It is explicitly contemplated that the user client device used by an individual creating a wearer record could include a camera and the data capture interface served in the data capture step permits the use of the camera for live capture of the single wearer image. The data capture interface would provide a visual image capture rates to coach the appropriate positioning of the camera for the proper selection of the standardized location for the capture of the single wearer image, in a standardized scale, to maximize as otherwise outlined herein the perspective congruence between the wearer avatar and the rendered clothing overlays as applied to the avatar.

It is explicitly contemplated that in certain embodiments of the system and method of the present invention the wearer details which might be transmitted from the user device to the server could include the height of the wearer being fitted which would be used to render the visual image capture aids for coaching the positioning of the camera in position and scale. The height of the wearer is the primary measurement required for the system and method to understand and capture an appropriately scaled side view image.

Just as there can be many different approaches taken to the overarching workflow of a wearer record creation subroutine in accordance with the remainder of the method of the present invention, there are also many types of clothing record creation subroutine workflows which can be contemplated within the scope of the present invention which would result in the capture of the necessary information to create a complete and relevant clothing record pertaining to a particular size of a particular clothing article in the clothing database.

In a first embodiment of the clothing record creation subroutine, the first step would be a data capture step which again similar to that outlined with respect to the wearer record creation subroutine data capture step outlined above would consist of the service of the data capture interface to the user client device originating related clothing creation request, permitting the entry of clothing details for capture to the server. The clothing details which would be captured would comprise at least identified details the clothing article, as well as a clothing size value corresponding to the manufactured size of the clothing article in question. Visual details of the garment would also be included for the purpose of rendering the most visibly accurate or appealing appearance of the clothing article in question in the size in question onto the avatar of the wearer in the practice the remainder of the method.

The details of the clothing article captured in the data capture step would also include a single clothing image being a photo image of the physical clothing article on a standard-sized mannequin corresponding to the clothing size value, captured from the side of the mannequin from a standardized location and in a standardized scale. In most particular clothing sizing scales there are series of standard size mannequins available for the display of those clothing articles, and the use of a standard-sized mannequin corresponding to the size of the clothing article will provide the most accurate image for the purpose of rendering a mathematical model of the garment. As well, the standard size mannequins are typically widely available in retail channels and thus will simplify and minimize the amount of equipment and costs involved in implementing the method of the present invention in existing retail channels.

The server would receive the completed and transmitted clothing details from the user client device and then, using the single clothing image, the fitting software component would generate a clothing overlay model being a mathematical model by which a three-dimensional rendering of the clothing article positioned on a standard body size can be created. As in the case of the wearer avatar models outlined above, the clothing overlay models could be generated by multiple mathematical approaches all of which are contemplated within the scope of the present invention insofar as they all result in the creation of the necessary data and process your instructions which can subsequently be used by the server or another computer processor to render a graphic clothing overlay model applied to a wearer avatar model in accordance with the remainder of the present invention. For example, the clothing overlay model might accommodate stretching or other appearance alterations of the rendered clothing article dependent upon the shape and size of the wearer avatar applied thereunder i.e., so that the wearer using the virtual fitting method of the present invention can see if a particular clothing article will fit tightly, loosely, or correctly and how it will stretch or apply over particularly shaped her sized body parts.

In the completion of the clothing record creation subroutine, the software and the server will create and store a clothing record in the clothing database corresponding to the captured clothing details and the generated clothing overlay model.

The system and software the present invention could provide a software interface by which manufacturers or retailers seeking to use the system and method of the present invention for virtual fitting and retail purposes could rapidly create clothing records for use in accordance with the remainder of the system and method—for example using user client devices that include a camera wherein the data capture interface served in the data capture step of the clothing record creation subroutine permits the use of the camera for the live capture of the single side clothing image, and the data capture interface provides visual image capture aids to coach the appropriate positioning of the camera for the proper selection of the standardized location for capture of said single clothing image in the desired standardized scale.

In certain embodiments the clothing details transmitted from the user to the server in the building record creation subroutine could include the height of the mannequin on which the clothing article is being photographed, whereby the height of the mannequin is used to render the visual image capture aids and results in the capture of appropriate images and the rendering of appropriate mathematical modelling in as close as possible to an identical scale as those of the wearer records and related wearer avatar models.

In certain cases, the clothing details transmitted from the user for the creation of a clothing record could include a standard size of the mannequin on which the clothing article is being photographed, rather than the height of the mannequin, and the height of the mannequin could be determined by the fitting software component from a dataset of heights of standardized mannequin size indicators. This would further simplify the process of rapidly creating multiple clothing records in the clothing database for the deployment of the method of the present invention.

Clothing records stored within the clothing database could include at least one photograph of the clothing article on a mannequin from which accurate color, pattern and other details could be captured in the rendering of a fitting image. Approaches such as this would result in the ability to provide the most realistic interface.

The fitting software component will have the necessary mathematical modelling components associated therewith not only for the purpose of accurately rendering a three-dimensional mathematical wearer avatar model of the wearer for the purpose of subsequently re-rendering the shape of the body of the wearer in a three-dimensional format for application of clothing articles thereto, as well as for the rendering of clothing overlay models, being the necessary data to subsequently render and apply a particular size of a particular clothing article to the wearer avatar of the wearer for the purpose of visual consideration by the video interface of the user device of the application of that particular article to the body of the wearer and assessment of its desirability for purchase. Any type of a mathematical modelling software capable of rendering these mathematical models for the purpose of the subsequent rendering of graphic or visual displays of particular wearer-based wearer avatar is with particular clothing articles in particular sizes applied thereto will be understood to be within the scope of the present invention.

The system and method of the present invention could be offered on a service bureau basis whereby the server and software thereof could be connected via an API or otherwise into third-party shopping cart or e-commerce website platforms for the purpose of virtual fitting of clothing articles, or in other approaches, the system and method of the present invention could be deployed on a single vendor basis within a particular single vendor website environment. Both such approaches will be understood to those skilled in the art and the necessary modifications etc. are all contemplated within the scope of the present invention to achieve such approach.

In a virtual fitting, based upon a virtual fitting request received from a client device, the server would permit the selection of a corresponding wearer record from the wearer database which is the selected wearer record. That could be facilitated by login credentials which equated to a particular wearer record, or the user can input particular search criteria to select the appropriate wearer record. Any type of an approach resulting in the selection of the appropriate wearer record corresponding to the user will be understood to be within the scope of the present invention.

Following are at the same time as the selection of a particular wearer record, the system will also facilitate the selection of at least one clothing article to be fitted and following the selection of the selected wearer record the system could present options or the user could select one or more corresponding clothing records corresponding to the clothing article to be fitted and approximating the appropriate garment size of the wearer record. These would be the selected clothing record or records.

The fitting software component would generate a combined fitted avatar model in respect of the selected wearer record and each selected clothing record, whereby the combined fitted avatar model would be a mathematical model combining the wearer avatar model of the selected wearer record with the clothing overlay model and visual details of the clothing article sort of the selected clothing record, such that the combined fitted avatar model information could be used to do that graphically render a three-dimensional fitting image on the video display of a user client device for a three-dimensional simulated view capable of manipulation, of the clothing article on the wearer.

The fitting generation and display system of the present invention could be deployed in multiple e-commerce environments. In certain embodiments, a system in accordance with the present invention could automatically locate clothing records corresponding to clothing articles in sizes of which the clothing overlay model is suggestive of the fact that it would fit a particular wearer avatar model, and those articles and items could then be displayed to the customer for further review, detailed sizing, and fitting review etc. In other variations, a system in accordance with the present invention could be used to render combined views of wearer avatar models that particular clothing overlay models based upon selection of particular size for clothing article combinations by a user.

The software of the present invention for integration with e-commerce platforms of areas types, along with the method of virtual government fitting outlined herein, and a server hosting the databases and software component outlined for the purpose of achieving the objectives of the present invention are all intended to be within the scope of this provisional disclosure and capable of claiming at a later date.

### DESCRIPTION OF THE DRAWINGS

To easily identify the discussion of any particular element or act, the most significant digit or digits in a reference number refer to the figure number in which that element is first introduced. The drawings enclosed are:

FIG. 1 is a schematic diagram of one embodiment of the system of the present invention including client devices for demonstrative purposes;

FIG. 2 is a block diagram demonstrating one embodiment of basic data structures of the databases of the system of FIG. 1.

FIG. 3 is a block diagram demonstrating the key components of one embodiment of the server in accordance with the present invention;

FIG. 4 comprises a flowchart demonstrating the steps of a first embodiment of the method of the present invention;

FIG. 5 is a flowchart showing the steps in one embodiment of a wearer record creation subroutine for association with FIG. 4;

FIG. 6 is a flowchart showing the steps in one embodiment of a clothing record creation subroutine for association with FIG. 4;

FIG. 7 is a flowchart showing the steps in one embodiment of a virtual fitting transaction for association with FIG. 4;

FIG. 8 is an entity diagram showing the placement of the body of the wearer and the camera in the capture of an image for use in a wearer record creation transaction in accordance with an embodiment of the present invention;

FIG. 9 is an entity diagram showing the placement of the mannequin with a clothing article thereon of a particular size, along with the camera positioned for the capture of an image for use in a clothing record creation transaction in accordance with an embodiment of the present invention;

FIG. 10 demonstrates the combination of the wearer avatar and the clothing overlay created in FIGS. 8 and 9, in accordance with certain embodiments of the present invention;

FIG. 11 shows the establishment of certain data anchor points with respect to the wearer avatar model or the clothing overlay model by establishing certain attachment points of the clothing article to the body of the mannequin or the wearer;

FIG. 12 is a sample screenshot of a retail e-commerce system incorporating the virtual fitting system of the present invention, showing a selection of clothing records corresponding to clothing articles in sizes which the system is determined would be capable of fitting the avatar of the user; and

FIG. 13 is an alternate screenshot of the system shown in FIG. 12 in which a particular clothing item has been selected by the user and is shown graphically superimposed on the avatar of the user.

### DETAILED DESCRIPTION OF ILLUSTRATED EMBODIMENTS

As outlined herein, the present invention comprises a virtual garment fitting method for displaying images of simulated graphical models of clothing articles on the body of a wearer using scale-standardized models of the clothing articles and the body of the wearer, using pre-existing garment sizing scales and equipment to generate the graphical models of the clothing articles for use.

### Entities:

There are a number of entities to be considered in understanding the operation and efficacy of the method of the present invention. The system is intended to enable individuals seeking to purchase clothing items from online retailers to participate in a virtual fitting room environment that has the highest level of accuracy in terms of showing the potential fit of an article on to a virtual avatar of the individual's body, all of which is done in a way that uses pre-existing clothing scales and sizing to simplify implementation for vendors as well as to simplify adoption for purchasers.

A couple of key entities to consider are the wearer and the vendor. The wearer is an individual who seeks to participate in the fitting method of the present invention, first by creating a wearer record corresponding to their body in the system and then participating in three-dimensional fitting and viewing of virtual clothing overlays of varying types and sizes on to the body within their wearer record.

A vendor is the company seeking to sell clothing articles in accordance with the virtual fitting method of the present invention. In many cases the vendor would be responsible for the creation and administration of clothing records in accordance with the remainder of the method and in certain embodiments, the vendor would rely upon a centrally created and maintained clothing database from third-party—in a service bureau embodiment of the method of the present invention.

### System and Architecture Overview:

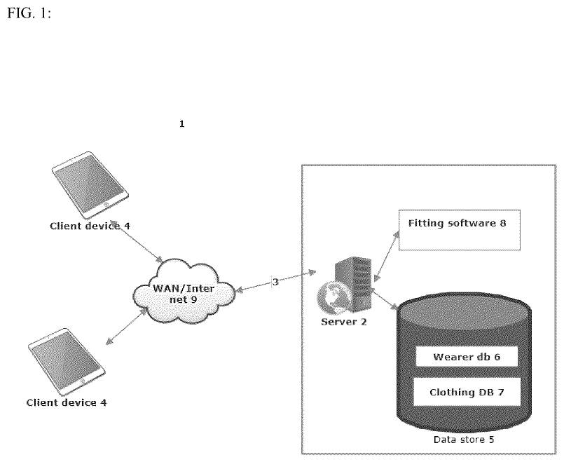

For the purpose of describing the method of the present invention we will now describe briefly the overall architecture of the system 1 of the present invention as required for the purpose of describing the invention. Referring to FIG. 1 there is shown a schematic diagram of the system 1 of the present invention. The system 1 comprises a server 2 having a network interface 3 capable of communication with user client devices 4. The user client devices 4 are shown connected to the server 2 via the Internet 9. The user client device 4 terminology is used to refer to client devices 4 connectable to the server 2 both for use by wearers as well as vendors in accordance with the remainder of the system and method of the present invention. It is assumed that in many cases the server 2 would communicate with the client devices 4 through a browser interface or something similar, which would make it very easy for a consolidated communications client to be used in any kind of a client device 4—any type of an approach which results in either a browser interface or locally installed client software on a client device 4 or use either by a vendor or a wearer in accordance with the remainder the present invention will be understood to be within the scope hereof.

The server 2 would also include or be operatively connected to a data store 5, capable of hosting or containing a plurality of databases for the practice of the method of the present invention. Shown are the wearer database 6 and a clothing database 7. Details of an example of a data structure for these databases are shown in subsequent Figures.

In addition to the necessary other software and hardware components of any type of server 2, the server 2 also includes as an additional component particularly required for the practice of the method of the present invention a fitting software component 8, operable on the server and capable of executing the steps of the method.

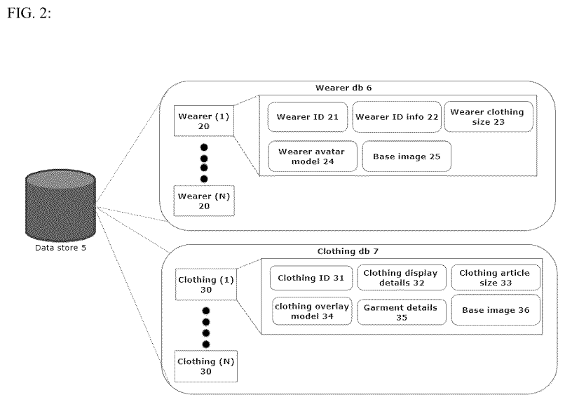

Referring to FIG. 2 there is shown a demonstrative data structure for the data store 5 and the wearer database 6, clothing database 7. Each of these databases 6, 7 are shown in this Figure. As will be obvious to those skilled in the art other types of data structures could also be used in which each of the databases 6, 7 could be data residing within a single database structure. Either a single consolidated dataset for individual or silo databases will be understood to be within the intended scope of the present invention.

The wearer database 6 consists of a plurality (N) of wearer records 20, corresponding to each wearer using the system and method of the present invention. Each wearer record 20 includes the necessary fields or data to practice the method—in basic embodiments, the wearer record 20 would include a serial key or wearer identifier 21, any wearer identifying information 22, wearer size value 23 corresponding to the standard scale clothing size of the wearer, and the wearer avatar model 24 comprising the necessary derived or rendered mathematical information which is required to subsequently generate a three-dimensional view of the body of the particular wearer for application of clothing overlays thereto. The wearer record 20 might also include a saved copy of the single side captured base image 25 of the body of the subject wearer which is used to generate the wearer avatar model 24, although it may or may not be necessary to save that image. It will be understood to those skilled in the art of database design and the design and execution of various fitting room systems and methods such as that outlined herein that additional functionality could be added to the system and method of the present invention that might require the storage of additional wearer related information in the wearer database 6, and the data structure of each wearer record 20 could be modified accordingly and is contemplated with any such modification to remain within the scope of the invention as described and claimed herein.

The clothing database 7 consists of a plurality (N) of clothing records 30, each of which corresponds to a clothing article offered for sale by a vendor in a particular clothing size of the pre-existing scale shared with the scale indicator stored in respect of standard sizes worn and stored in the wearer records.

Each clothing record 30 includes the necessary fields or data to permit the ultimate application of an overlay of the clothing article in the particular size to a wearer avatar representing the wearer avatar model of a particular wearer record. In the embodiment shown, the clothing record 30 includes a serial key or clothing identifier 31. Additionally, the clothing record 30 as indicated will contain any necessary article details 32 which might include sales options or information like colors, available patterns, or other text information to be displayed to a customer. Also shown is a clothing size value 33 stored in respect of the clothing record and the clothing article in question. The clothing record would also include a clothing overlay model 34 being a mathematical model permitting the graphic rendering of a three-dimensional overlay of the clothing article onto a wearer avatar on the video display of a user device. The clothing overlay model 34 is generated based upon a single captured clothing image, being a photo image of the physical clothing article on a standard-sized mannequin corresponding to the clothing size value, captured from the side of the mannequin from a standardized location and in a standardized scale. Visual details of the garment 35 could also be stored to permit the coloring or patterning of the rendered clothing overlay on the avatar of the wearer to provide the most accurate and fulsome fitting experience—i.e., details of fabric patterns, colors etc. which would permit the proper rendering of color or pattern on the combination of the clothing overlay and the wearer avatar. Finally, as shown, the base image 36 used to generate the clothing overlay model 34 is also shown.

Depending upon the nature of the fitting software component 8 insofar as it accomplishes the superimposition of a clothing overlay model 34 onto a wearer avatar model 24, if the software and the methodology comprises simply overlaying the clothing article onto the wearer's body the models 24 and 34 could be stored as actual images. In other embodiments, the fitting software component 8 could rendered the wearer and clothing models 24, 34 from stored mathematical data so stored mathematical data to drive a graphic rendering engine could also be what comprised each of the wearer avatar model 20 for the clothing overlay model 34 as stored. Either such approach is contemplated within the scope of the invention.

### Server:

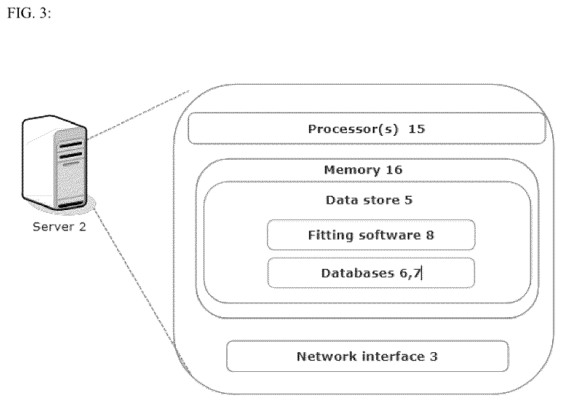

FIG. 3 shows one embodiment of a server 2 in accordance with the present invention. The method of the present invention and the overall architecture would be client/server in nature and would rely on a server 2 configured for use in the processing of virtual fitting data transactions in accordance with the method. The server 2, a sample embodiment of which is shown in FIG. 3, might consist of one or more servers 2-a single server or a server farm approach. The server 2 would comprise one or more processors 15 and memory 16. The memory 16 might contain various software components or a series of processor instructions for use in the method of the present invention or otherwise in the operation of the server 2. Processor instructions corresponding to the fitting software component are shown stored within the memory 16 in this Figure.

Memory 16 may comprise non-transitory storage media that electronically stores information. The electronic storage media of memory 16 may include one or both of system storage that is provided integrally (i.e., substantially non-removable) with server(s) 1 and/or removable storage that is removably connectable to server(s) 1 via, for example, a port (e.g., a USB port, a firewire port, etc.) or a drive (e.g., a disc drive, etc.). Memory 16 may include one or more of optically readable storage media (e.g., optical discs, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Memory 16 may include one or more virtual storage resources (e.g., cloud storage, a virtual private network, and/or other virtual storage resources). Memory 16 may store software algorithms, information determined by processor(s) 15, information received from server(s) 2, information received from client devices, and/or other information that enables server(s) 2 to function as described herein.

Processor(s) 15 may be configured to provide information processing capabilities in server(s) 2. As such, processor(s) 15 may include one or more of a digital processor, an analogue processor, a digital circuit designed to process information, an analogue circuit designed to process information, a state machine, and/or other mechanisms for electronically processing information. In some implementations, processor(s) 15 may include a plurality of processing units. These processing units may be physically located within the same device, or processor(s) 15 may represent processing functionality of a plurality of devices operating in coordination.

In many embodiments, the server 2 is contemplated to be a Web server, where client devices would use a web browser for interaction therewith. Where a local app was developed, server 2 might not be a Web server per se but might be a server 2 capable of interaction with that type of an interface on remote client devices. Either such approach is contemplated within the scope hereof.

Server 2 would also include at least one network interface 3 via which it could communicate with the at least one communications network for the purpose of enabling communication with the user client devices of the remainder of the method as outlined herein. It will be understood by those skilled in the art of network design and hardware and software design that certain server architectures might include more than one network interface 3 and any type of a server 2 and network interface 3 design which enabled the communication of the server 2 as outlined in the remainder of the method would all be contemplated within the scope of the present invention.

### Fitting Software Component:

The server of the present invention hosts a fitting software component for executing the steps of the method. The fitting software component will comprise any combination of locally stored or locally accessible processor instructions for execution on the server in conjunction with its hardware components and in communication with networked client devices to aid the execution of the virtual fitting method as further outlined herein.

The fitting software component 8 resident on or accessible to the server 2 would be key to the performance of the present method. Functions of the fitting software component 8 would include the creation, administration, and maintenance of database records within the databases 6, 7 along with interacting with client devices as required for the purpose of facilitating the method. The fitting software component 8 could also encompass any additional required querying, reporting or added software functionality.

The fitting software component 8 will comprise any compiled processor instructions capable of being executed by the processor of the server 2. It will be understood that any fitting software component 8 having the effect of being able to administer the method of the present invention as outlined is contemplated within the scope of the present invention.

The fitting software component will have the necessary mathematical modelling components associated therewith not only for the purpose of accurately rendering a three-dimensional mathematical human avatar model of the wearer for the purpose of subsequently re-rendering the shape of the body of the wearer in a three-dimensional format for application of clothing articles thereto, as well as for the rendering of clothing overlay models, being the necessary data to subsequently render and apply a particular size of a particular clothing article to the human avatar of the wearer for the purpose of visual consideration by the video interface of the user device of the application of that particular article to the body of the wearer and assessment of its desirability for purchase. Any type of a mathematical modelling software capable of rendering these mathematical models for the purpose of the subsequent rendering of graphic or visual displays of particular wearer-based human avatar is with particular clothing articles in particular sizes applied thereto will be understood to be within the scope of the present invention.

The fitting software component 8 might comprise a core software engine with additional mathematical modules attached for the purpose of rendering the various mathematical models of the graphics in question. The mathematical and graphic rendering components insofar as they are interoperable or connected with the primary fitting software component would for the purpose of this disclosure comprise a part of the fitting software component and overall and in aggregate comprise a portion of the contemplated fitting software component 8 and its functionality.

### Client Software:

It is specifically contemplated that the system and method of the present invention would be facilitated by the provision of client software for use on the user client devices 4 conjunction with the server 2. A single client software application could be provided for use by both wearers and vendors or clothing system administrators, or separate client software applications could be developed for each use. Both such approaches will be understood to be within the scope and contemplated within the scope of the present invention.

The client software application could be programmed to operate in conjunction with the camera of a user client device 4 to permit the capture of site captured images of the body of the wearer or of a clothing article on a mannequin for use in the creation of wearer records or clothing records in the database. Effectively the client software application could provide guidance to the operator of the user client device 4 to capture an appropriately scaled and positioned image, either in the case of capturing a side captured image of a particularly sized clothing article on a mannequin for the creation of a clothing record, or for a site captured image of the body of a wearer for the creation of a wearer record.

### Visual Image Capture Aids:

As outlined throughout, the key to the system and method of the present invention is that the equipment requirements are nominal for either the wearer or the clothing vendor seeking to create a corresponding database record, since only a single side captured image from a camera of a mobile device could be used to generate the necessary mathematical model for either a wearer avatar model or a clothing overlay model. Each of these images would be captured from a similar camera position, so that the models generated as congruent as possible. The system of the present invention could provide visual image capture aids to simplify the selection of the proper camera positioning for the capture of these side images—where a client application was provided for use in conjunction with the server of the present invention, and the client application was intended for use on smart devices, tablets, phones etc. that had a built-in camera, the client application could work in conjunction with the software and hardware components of the user client device 4 and provide visual prompts on the screen of the device 4 to indicate the proper location for the capture of a side image which can be used to generate the necessary models. For example, visual positioning aids might include a centerline to indicate the proper vertical positioning of the camera in relation to wearer or the mannequin being photographed, or even for example the proper shoulder height or another horizontal height marking to capture a standardized image again properly for use in the generation of the necessary mathematical data for use in the combined image processing of the remainder of the present invention.

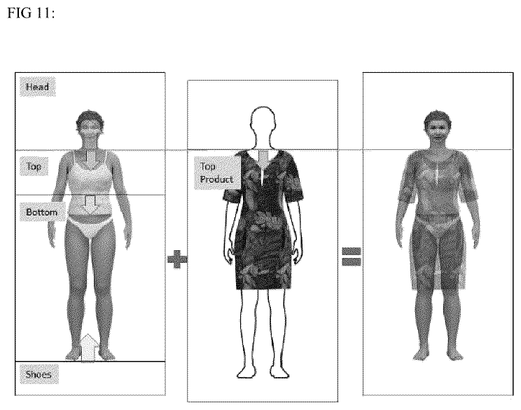

The visual image capture aids could be useful for the establishment of clothing attachment points to the body of the wearer or the mannequin, as discussed in relation to FIG. 11.

In certain embodiments of the system and method of the present tension, the interface of the client device application might capture the height of the wearer, or either the height or a standardized size of the mannequin on which the clothing applied, which could be used by the client application to properly coach the selection of the appropriate camera location for the image capture. Any type of visual interface aids which could aid the user in the capture of an image from the appropriate distance and positioning of the camera, as will be understood to those skilled in the art of software and camera interface design, are all contemplated within the scope of the present invention.

### Method Overview:

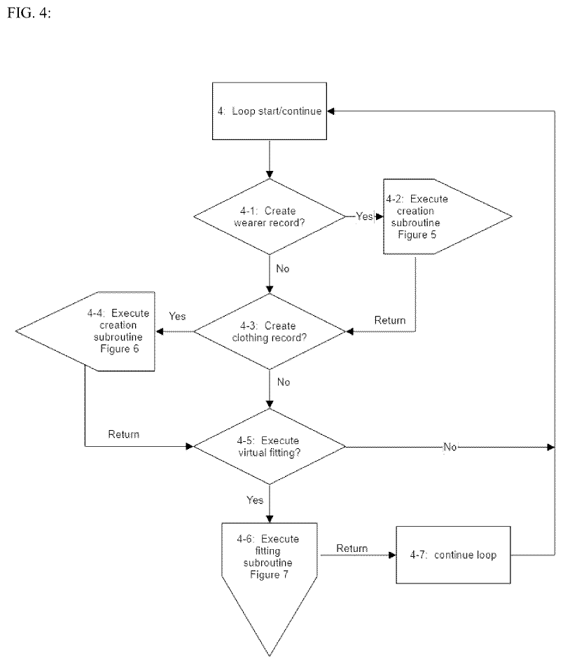

FIG. 4 is a flowchart demonstrating the steps of a first embodiment of the method of the present invention, in which users can create the necessary data records for the execution of virtual fittings in accordance with the of the present invention, as well as execute virtual fittings of clothing articles with a human avatar of the user for graphic display in accordance with the method. The method, as executed by the fitting software component 8 in accordance with the remainder of the system 1 of FIGS. 1 to 3, would as demonstrated be conducted in a perpetual loop fashion, although it will be understood to those skilled in the art of software design that there are many different orderings or approaches to the steps in the method as outlined which would still achieve the same objective and would not depart from the intended scope claimed herein.

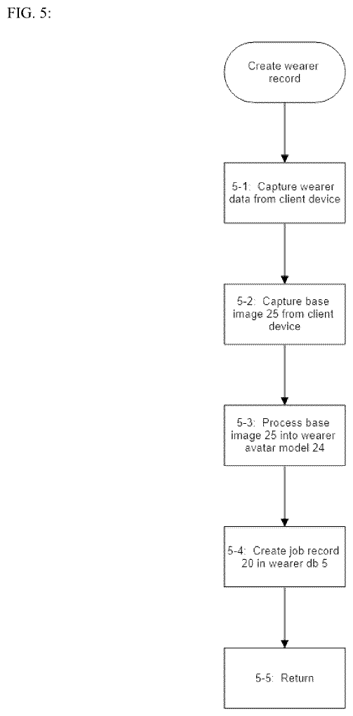

The method comprises using the server 2 and the fitting software component 8 to execute certain steps as required. The method shown in this Figure is a listener/repeat loop. A listener would determine if there was a requirement to create a wearer record for a new wearer in the system. If a user interaction from a user client device is detected requiring the creation of a wearer record 20, a wearer record creation subroutine is executed before returning to the primary repeat loop. Detection of the condition requiring creation of a wearer record is shown at step 4-1, and the off page execution of the creation subroutine of FIG. 5 is shown at step 4-2.

If it is desired to create a wearer record 20 and the subroutine of FIG. 5 is activated, the server 2 in communication with a user client device 4 would capture data including wearer identifying information 22, wearer size value 23 corresponding to the standard scale clothing size of the wearer, and a single side captured image 25 of the body of the wearer captured from a selected distance and location to result in a standardized perspective and scale of the image. Capture of this information via a user interface interaction between the server 2 and the wearer client device 4 is shown at 5-1 and 5-2. The wearer details transmitted from the user device 4 to the server 2 could include the height of the wearer being fitted which would be used to render the visual image capture aids for coaching the positioning of the camera in position and scale. The height of the wearer is the primary measurement required for the system and method to understand and capture an appropriately scaled side view image 25.

Following the receipt of the captured wearer information at the server 2, the fitting software component 8 would generate the wearer avatar model 24, which comprises the necessary derived or rendered mathematical information or graphical data which is required to subsequently generate a three-dimensional graphical view of the body of the particular wearer for application of clothing overlays thereto. The wearer avatar model 24 is a mathematical or graphical model by which a three-dimensional rendering of the body of the wearer could be created for subsequent use and user interaction in the remainder of the method. Various types of mathematical and graphical modelling approaches could be used for this purpose. Effectively by using a single side view image 25 of the body of the wearer, the storable wearer avatar model 24 when completed would effectively comprise the data required to render a view of the body of the wearer which could properly show the fit or draping of a clothing article when applied thereto in a particular size. Following the generation of the wearer avatar model 24, the server 2 and software component 8 could then create and store a corresponding wearer record in the wearer database.

The wearer record 20 might also include a saved copy of the single side captured image 25 of the body of the subject wearer which is used to generate the wearer avatar model 24. Generation of the wearer avatar model 24 shown at step 5-3.

Following the generation of the wearer avatar model 24 a corresponding wearer record 20 would be created in the wearer database 6, shown at 5-4, and the subroutine would return control to the primary loop shown in FIG. 4.

It is explicitly contemplated that the user client device 2 used by an individual creating a wearer record 20 could include a camera and the data capture interface served in the data capture step permits the use of the camera for live capture of the single wearer image. The data capture interface would provide visual image capture aids to coach the appropriate positioning of the camera for the proper selection of the standardized location for the capture of the single wearer image, in a standardized scale, to maximize as otherwise outlined herein the perspective congruence between the wearer avatar and the rendered clothing overlays as applied to the avatar.

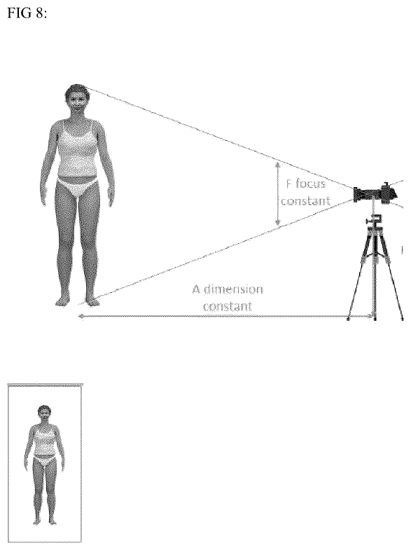

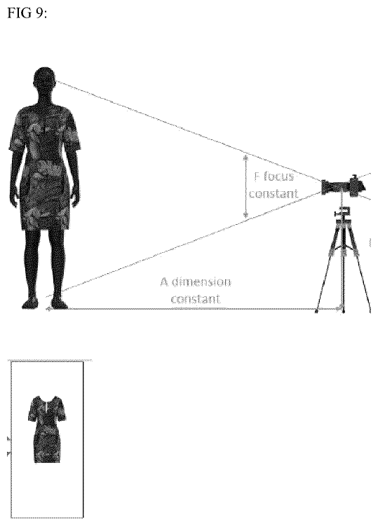

FIG. 8 demonstrates the positioning of the camera in relation to the body of the wearer being captured from the side for the purpose of generating the side captured image to be used in creation of a wearer avatar model. The constant focus distance and spacing of the camera from the body can be seen and compared to that of FIG. 9 which is showing the capture of a similar imagery for use in the creation of clothing overlays models.

As will be understood by those skilled in the art of database design and software design, many different wearer record creation subroutine workflows could be created within the scope and intention of the present invention.

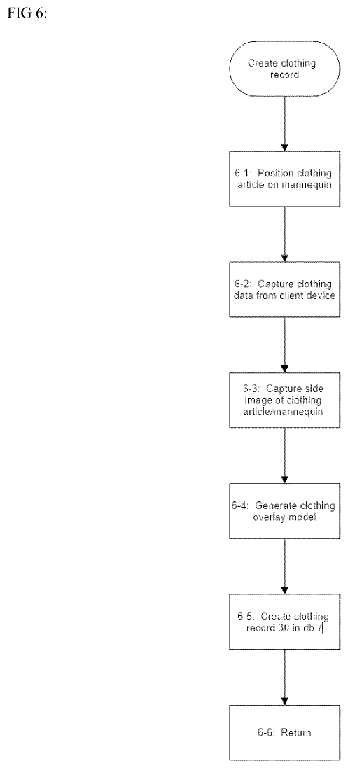

Returning to FIG. 4, shown next at 4-3 is another listener seeking indication of the requirement for the creation of a clothing record 30 in the clothing database 7. Upon initiation of a communication session or interaction for the creation of a clothing record 30, or receipt of indication from a client device indicating a desire to create a clothing record, a clothing record creation subroutine is executed before returning to the primary repeat or monitoring loop. Detection of the condition requiring the creation of a clothing record is shown at step 4-3, and the triggering of the off page execution of the creation subroutine of FIG. 6 is shown at step 4-4.

On receipt of a clothing record creation request from a user client device, the server 2 and software component 8 could execute a clothing record creation subroutine to create a clothing record corresponding to a particular size of a particular physical garment for use in the remainder of the fitting method in the clothing database.

In the creation of a clothing record 30 as outlined in the clothing record creation subroutine of FIG. 6, a user client device 4 could interact and transmit clothing data to the server 2. The clothing article of the particular clothing scale size would be placed on a mannequin and positioned for photography, shown at 6-1. Clothing data as would be captured for storage to a clothing record 30 could include identifying information which could be used in a sale display etc. The capture of clothing data from the client device, including identification details or sale details to be used in the rendering of e-commerce interfaces for the clothing article, the clothing article scale or size, as well as the mannequin height or size and any other additional information which is desired or required, is shown at step 6-2.

The client software deployed to the client device 4 in communication with the server 2 can then coach the user through the appropriate position to capture a side image of the clothing article mannequin which image can be transmitted to the server 2 used in the rendering or completion of the clothing overlay model 34 for mathematical or graphical rendering use subsequently in the overlay at image of the clothing article onto a wearer avatar (Step 6-3). Creation of the clothing overlay model 34 is indicated at step 6-4.

Following the capture of all the necessary information from the client device 4, the software 8 can create the clothing record 30 corresponding to the position in the clothing database 7, as shown at step 6-5. Control would then be returned to the main method and routine of FIG. 4 as the embodiment demonstrates.

FIG. 9 shows the positioning of the camera in relation to the mannequin and the clothing article for the capture of the necessary side captured image to render the clothing overlay model trade the constant focus and constant camera distance, equating to the focus in camera distance of the images used for the capture of the side captured image for the rendering of a wearer avatar model can be seen. The processing of the side captured image of the clothing article of a particular size on a mannequin could include color-based masking or another type of image masking approach which is used to mask off the exposed portions of the body of the mannequin. Any type of masking our mathematical modelling of this nature, resulting in a clothing overlay model which can be superimposed onto a wearer avatar model will be understood to be within the scope of the present invention.

As in the case of the wearer avatar models 24 outlined above, the clothing overlay models 34 could be generated by multiple mathematical approaches all of which are contemplated within the scope of the present invention insofar as they all result in the creation of the necessary data and process your instructions which can subsequently be used by the server or another computer processor to render a graphic clothing overlay model applied to a human avatar model in accordance with the remainder of the present invention. For example, the clothing overlay model might accommodate stretching or other appearance alterations of the rendered clothing article dependent upon the shape and size of the human avatar applied thereunder i.e., so that the wearer using the virtual fitting method of the present invention can see if a particular clothing article will fit tightly, loosely, or correctly and how it will stretch or apply over particularly shaped her sized body parts.

In the completion of the clothing record creation subroutine, the software 8 and the server 2 will create and store a clothing record 30 in the clothing database 6 corresponding to the captured clothing details and the generated clothing overlay model.

The system and software of the present invention could provide a software interface by which manufacturers or retailers seeking to use the system and method of the present invention for virtual fitting and retail purposes could rapidly create clothing records for use in accordance with the remainder of the system and method—for example using user client devices that include a camera wherein the data capture interface served in the data capture step of the clothing record creation subroutine permits the use of the camera for the live capture of the single side clothing image, and the data capture interface provides visual image capture aids to coach the appropriate positioning of the camera for the proper selection of the standardized location for capture of said single clothing image in the desired standardized scale.

In certain embodiments the clothing details transmitted from the user to the server in the clothing record creation subroutine could include the height of the mannequin on which the clothing article is being photographed, whereby the height of the mannequin is used to render the visual image capture aids and results in the capture of appropriate images and the rendering of appropriate mathematical modelling in as close as possible to an identical scale as those of the wearer records and related human avatar models.

In certain cases, the clothing details transmitted from the user for the creation of a clothing record could include a standard size of the mannequin on which the clothing article is being photographed, rather than the height of the mannequin, and the height of the mannequin could be determined by the fitting software component from a dataset of heights of standardized mannequin size indicators. This would further simplify the process of rapidly creating multiple clothing records in the clothing database for the deployment of the method of the present invention.

Clothing records stored within the clothing database could include at least one photograph of the clothing article on a mannequin from which accurate color, pattern and other details could be captured in the rendering of a fitting image. Approaches such as this would result in the ability to provide the most realistic interface.

Certain embodiments of the system and software the present invention could provide for a one-dimensional forward or rear view of the clothing overlay applied to the avatar of the wearer. In other cases a three-dimensional model could be rendered providing the ability to pivot or otherwise manipulate same. Both such approaches are contemplated within the scope of the present invention.

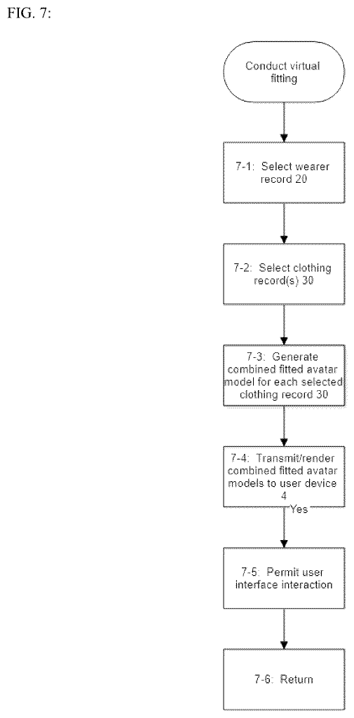

Referring to FIG. 7 the fitting software component 8 can then execute virtual fitting request based on wearer and clothing records stored. On receipt of a virtual fitting request from a client device 4 in respect of and containing details corresponding to a wearer and a clothing article to be fitted the fitting software component 8 could execute a fitting rendering step by first selecting a corresponding wearer record 20 from the wearer database 5, being the selected wearer record, and selecting at least one clothing record from the clothing database corresponding to the clothing article to be fitted, by matching the wearer size value from the corresponding wearer record against the clothing size value for clothing records corresponding to the clothing article, being the selected clothing records. Selection and acquisition of the details of the selected wearer record 20 and one or more clothing records 30 are shown in steps 7-1 and 7-2.

In certain cases, a single clothing record with matching size values could be offered for selection or selected, and in other cases the system might for example select a matching size record along with sizes up and down to provide different views of similarly or closely sized versions of the clothing article in question to allow the wearer to visually assess the fit of different close sizes of the article. Both such approaches and necessary method and system modifications are understood to be within the scope of the present invention.

Following the selection of at least one selected clothing record, corresponding to a particular size of a clothing article, the fitting software component will generate a combined fitted avatar model in respect of each selected clothing record, being a mathematical or graphic model combining the wearer avatar model of the selected wearer record with the clothing overlay model of the selected clothing record-effectively superimposing the image of the particular size of the corresponding clothing article onto the avatar of the wearer. Generation of the combined fitted avatar models is shown at step 7-3.

In step 7-4 as shown in the flowchart of the embodiment of FIG. 7 the combined fitted avatar models would be transmitted or rendered on the use or display of the user device 4, for a three-dimensional simulated view capable of manipulation of the clothing article on the body of the wearer. The flowchart of FIG. 7 shows at step 7-5 the facilitation of user interface interaction with the user device and the combined fitted avatar model allowing for adjustment of the view, transparency etc. for the purpose of making educated fitting and selection decisions.

In a virtual fitting, based upon a virtual fitting request received from a client device, the server would permit the selection of a corresponding wearer record from the wearer database which is the selected wearer record. That could be facilitated by login credentials which equated to a particular wearer record, or the user can input particular search criteria to select the appropriate wearer record. Any type of an approach resulting in the selection of the appropriate wearer record corresponding to the user will be understood to be within the scope of the present invention.

Following or at the same time as the selection of a particular wearer record, the system will also facilitate the selection of at least one clothing article to be fitted and following the selection of the selected wearer record the system could present options or the user could select one or more corresponding clothing records corresponding to the clothing article to be fitted and approximating the appropriate garment size of the wearer record. These would be the selected clothing record or records.

The fitting software component would generate a combined fitted avatar model in respect of the selected wearer record and each selected clothing record, whereby the combined fitted avatar model would be a mathematical model combining the wearer avatar model of the selected wearer record with the clothing overlay model and visual details of the clothing article sort of the selected clothing record, such that the combined fitted avatar model information could be used to do that graphically render a three-dimensional fitting image on the video display of a user client device for a three-dimensional simulated view capable of manipulation, of the clothing article on the wearer.

The system of the present invention permitting for virtual fitting could be integrated into a freestanding e-commerce system, providing the ability for purchasers to virtually try on the garments of one or more sizes to view them in advance of purchase and thus the integration could also facilitate a shopping cart function etc. where purchases could be facilitated through the vendor website. Alternatively, the system and method of the present invention could also be modified to include the necessary shopping cart functionality to internally facilitate product sales. Both such approaches are contemplated within the scope of the present invention.

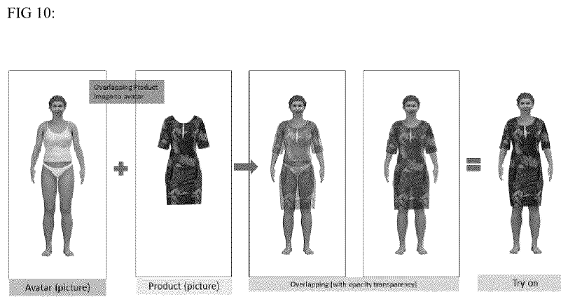

The standardized image capture position and scale of the single wearer image and the single clothing image used to generate the avatar model and clothing overlay model combined in the fitting rendering step result in maximized perspective congruence between said models and maximized accuracy in the rendered fitting image. Referring to FIG. 10 there is shown a demonstrative example of the overlay of the properly scaled clothing article onto the wearer avatar of a user. The particular nature of that superimposition or other graphic blending of the two models is intended only demonstratively any number of different particular mathematical or graphic approaches to this will be possible without departing from the scope of the present invention and are intended to be covered thereby.

### Clothing Record Creation Workflow:

In the front to back workflow of the creation of clothing records in accordance with the remainder of the system of the present invention, there are physical steps which would be required in addition to capturing the side oriented image of a sized garment on a mannequin, along with the necessary additional data to create the clothing record. As outlined throughout, it is contemplated that one of the means of providing the most standardized and congruous mathematical clothing overlay models is to capture those images of the clothing article itself displayed on a mannequin of a standard size. In the clothing retail business there are scale manikins available, and a company wishing to sell clothing through the virtual fitting system of the present invention or otherwise would typically have access to a set of standardized scale mannequins. Which could be used for this purpose. For example a female size 8 mannequin could be used to capture images of size 8 clothing articles, and a size 10 mannequin could be used to capture the necessary images of size 10 clothing articles. By using a standardized scale of mannequins each having shape profile accommodating different garment sizes, the most standardized and congruous mathematical models for the clothing overlays can be generated. If the clothing articles are generated using a standardized set of mannequins, the actual clothing overlay models and other information or complete clothing records themselves could also be distributed by clothing manufacturers for uploading to the clothing database of systems in accordance with the present invention of particular vendors, while permitting for the best possible standardized mathematical models to be used.

### Software Modeling Components:

As outlined, the fitting software component 8 will include numerous elements which will have the purpose of rendering mathematical or graphical models of the body of clothing wearers, of clothing articles displayed on a standardized mannequin, or also of the rendering of a combined graphical display model of a particular clothing article superimposed on the body of a particular wearer by rendering a combined model and image of a particular wearer avatar model and a selected clothing overlay model. The necessary software algorithms and mathematical modeling required to render the data to store wearer avatar models and clothing overlay models in accordance with the remainder of the present invention, based upon a single side captured image of the body of the wearer or the clothing article displayed on a standardized scale mannequin, are all contemplated within the scope of the present invention insofar as they will be understood to those skilled in the art of mathematical graphic modeling etc.

Particularly in the case of the side captured image of the clothing article on the standard scale mannequin, the mathematical clothing overlay model might include the necessary data to properly render colors, patterns etc. of the fabric of the clothing article also, or that information could be separately stored within a clothing record and superimposed in the image blending step of the wearer avatar model at the clothing overlay model. Any such approaches contemplated within the scope of the present invention.

It may also be desired where clothing articles are available in multiple patterns or colors to create separate clothing records for each particular combination of a size and pattern or color based upon a separately captured side image of that clothing article combination on the mannequin in question, or in certain body months of the present invention and will be understood that the colors or patterns could be stored as additional information within the related clothing record for the clothing article and size combination and imposed upon the combined image of the wearer avatar and the clothing overlay at the time of rendering of that combined article for display.

Similarly, any mathematical or software component capable of superimposing the clothing overlay models on top of the wearer avatar models and providing the necessary data for the rendering of that combined image on the visual display of a user client device are also contemplated within the scope of the present invention.

It may be possible or desirable in certain iterations of the system and method of the present invention for the fitting software component 8 to include integration or incorporation of third-party software components to be used for these mathematical modeling functions, and it will be understood that the fitting software component 8 might comprise locally installed or remotely connected software components of third parties to deliver the combined required functionality outlined herein and all such approaches are also contemplated within the scope of the present invention.

As shown in FIG. 11 the methodology beyond standardizing the perspective and scale of the images could also use the visual aids for image capture or other definition and data interaction tools provided within the user interface presented to the user in the creation of a clothing record to define particular portions of the image as particular blending points for attachment of the clothing overlay model with a wearer avatar model. For example, as shown in FIG. 11 the system could permit for the marking of the shoulder region, center region or otherwise on the body of either the wearer model or the clothing overlay model, and those might be specifically used for the purpose of anchoring the two images together when they are blended or superimposed for the purpose of the virtual fitting. All such approaches are contemplated within the scope of the present invention.

Also shown in this Figure is an additional virtual fitting benefit namely making the clothing article as superimposed on to the avatar of the wearer adjustably transparent, so that the user performing the virtual fitting can effectively transparently see through the clothing article to the body thereunder for the purpose of assessing fit etc.

The user interface of the virtual fitting transaction could also permit the “trying on” of an outline of the clothing article being an outline of the clothing overlay model, without any transparent pattern or texture shown in the center thereof. Any number of different interface modifications to allow for different views and enhanced trying on of clothing articles to the body of the wearer such as these will all be understood to be within the intention and scope hereof.

### Ecommerce Display:

The fitting generation and display system of the present invention could be deployed in multiple e-commerce environments. In certain embodiments, a system in accordance with the present invention could automatically locate clothing records corresponding to particular clothing articles in sizes of which the clothing overlay model is suggestive of the fact that it would fit a particular wearer avatar model, and those articles and items could then be displayed to the customer for further review, detailed sizing and fitting review etc. FIG. 8 is a sample screenshot of an embodiment of a user display of this nature on a website, where particular articles of clothing are shown that it is determined fit the wearer, and the wearer can then make further user interface interactions to post on their wearer avatar. FIG. 9 is a sample screenshot showing a particular clothing article superimposed on the avatar of the body of the wearer.

In other variations, a system in accordance with the present invention could be used to render combined views of wearer avatar models that clothing overlay models based upon selection of size for clothing article combinations by a user.

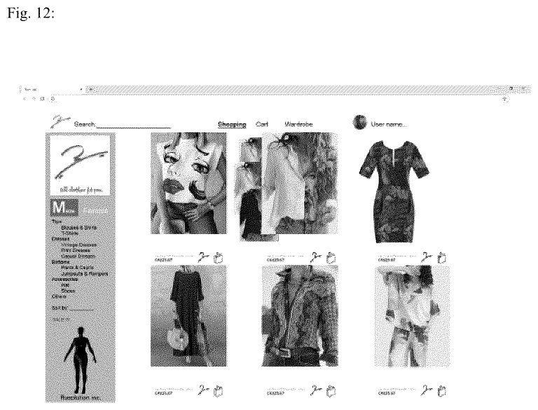

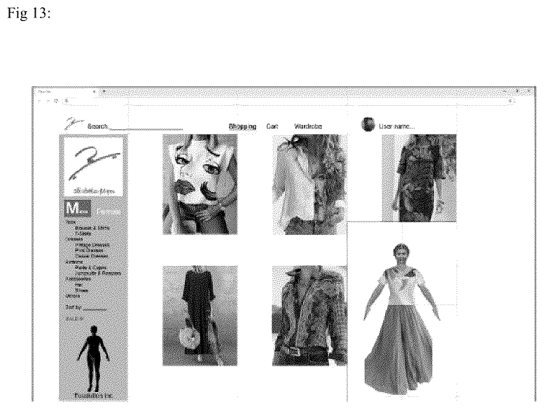

FIG. 12 is a sample screenshot of a retail e-commerce system incorporating the virtual fitting system of the present invention, showing a selection of clothing records corresponding to clothing articles in sizes which the system is determined would be capable of fitting the avatar of the user. FIG. 13 is an alternate screenshot of the system shown in FIG. 12 in which a particular clothing item has been selected by the user and is shown graphically superimposed on the avatar of the user. These Figures demonstrate only one sample embodiment of an e-commerce clothing sales system incorporating the virtual fitting methodology of the present invention.

It will be understood that the system and method of the present invention could be extended are used to provide fitting abilities by displaying wearer body and clothing overlay combinations to a user. For example a user interface to the remainder of wearer and clothing databases could be created which would permit a particular wearer to automatically view the superimposition of clothing overlays of only particular clothing articles in the right size to fit their body based upon the information stored in the corresponding wearer record, or in other iterations, the e-commerce system would allow the wearer upon authentication with the database system of the present invention either directly or through an API connection to a third party e-commerce site.

The core of the system and method of the present invention is the actual creation of the necessary data records and models to permit the virtual fitting method of the present invention to be practiced regardless of the specific e-commerce integration or ultimate customer delivery method. It will be understood that any type of an e-commerce site incorporating either as a direct connected and integrated component, or by a third party or API or the like, the system and necessary software of the present invention outlined herein for the purpose of practicing the enhanced garment fitting method of the present invention are all contemplated within the scope hereof.

It will be apparent to those of skill in the art that by routine modification the present invention can be optimized for use in a wide range of conditions and application.

It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. The terms “comprise” and “comprising” should be interpreted as referring to elements, components, or steps in a non-exclusive manner, indicating that the referenced elements, components, or steps may be present, or utilized, or combined with other elements, components, or steps not expressly referenced.

1. A virtual garment fitting method for displaying images of simulated models of clothing articles on the body of a wearer using scale-standardized models of the clothing articles and the body of the wearer, using a server comprising:
a. a processor and memory;
b. a network interface for communication with user client devices each having a user interface;
c. a fitting software component for executing the steps of the method;
d. a wearer database containing wearer records each corresponding to a clothing wearer and comprising at least:
i. the identification of the wearer;
ii. a wearer avatar model being a mathematical model permitting the graphic rendering of a three-dimensional wearer avatar on the video display of a user device, said wearer avatar model being generated based upon a single wearer image being a photo image of the body of the wearer captured from the side of the wearer from a standardized location and in a standardized scale; and
iii. a wearer size value corresponding to the clothing size of the wearer;
e. a clothing database containing a plurality of clothing records each corresponding to a clothing article in a particular manufactured size, each clothing record comprising at least the following values:
i. identifying details of the clothing article;
ii. a clothing size value corresponding to the manufactured size of the clothing article;
iii. a clothing overlay model being a mathematical model permitting the graphic rendering of a three-dimensional overlay of the clothing article for application to a wearer avatar on the video display of a user device, said clothing overlay model being generated based upon a single clothing image being a photo image of the physical clothing article on a standard-sized mannequin corresponding to the clothing size value, captured from the side of the mannequin from a standardized location and in a standardized scale; and
iv. visual details of the garment;
said method comprising, using the server and the fitting software component:
a. on receipt of a wearer creation request from a user client device, executing a wearer record creation subroutine to create a wearer record corresponding to a wearer desirous of using the fitting method in the wearer database;
b. on receipt of a clothing creation request from a user client device, executing a clothing record creation subroutine to create a clothing record corresponding to a particular size of a particular physical garment for use in the remainder of the fitting method in the clothing database;
c. on receipt of a virtual fitting request from a client device in respect of and containing details corresponding to a wearer and a clothing article to be fitted, executing a fitting rendering step by:
a. selecting a corresponding wearer record from the wearer database, being the selected wearer record;
b. selecting a corresponding clothing record from the clothing database corresponding to the clothing article to be fitted by matching the wearer size value from the corresponding wearer record against the clothing size value for clothing records corresponding to the clothing article, being the selected clothing record;
c. generating a combined fitted avatar model, being a mathematical model combining the wearer avatar model of the selected wearer record with the clothing overlay model of the selected clothing record;
d. rendering a three-dimensional fitting image using the combined fitted avatar model and the visual garment details from the selected clothing record; and
e. displaying the rendered fitting image on the video display of the user client device for a three-dimensional simulated view capable of manipulation of the clothing article on the body of the wearer;
wherein the standardized image capture position and scale of the single wearer image and the single clothing image used to generate the avatar model and clothing overlay model combined in the fitting rendering step result in maximized perspective congruence between said models and maximized accuracy in the rendered fitting image.

2. The method of claim 1 wherein the wearer record creation subroutine comprises:
a. in a data capture step, serving a data capture interface to the user client device originating the wearer creation request permitting the entry of wearer details comprising:
i. the identification of the wearer;
ii. a single wearer image being a photo image of the body of the wearer captured from the side of the wearer from a standardized location and in a standardized scale; and
iii. a wearer size value corresponding to the clothing size of the wearer;
b. receiving completed and transmitted wearer details from the user client device at the server;
c. using the single wearer image, generating a wearer avatar model being a mathematical model by which a three-dimensional rendering of the body of the wearer can be created; and
d. creating and storing a wearer record in the wearer database corresponding to the captured wearer details and the generated wearer avatar model.

3. The method of claim 2 wherein:
a. the user client device includes a camera;
b. the data capture interface served in the data capture step permits the use of said camera for live capture of the single wearer image; and
c. the data capture interface provides visual image capture aids to coach the appropriate positioning of the camera for the proper selection of the standardized location for capture of said single wearer image in the desired standardized scale.

4. The method of claim 3 wherein:
a. the wearer details transmitted from the user includes the height of the wearer being fitted; and
b. the height of the wearer is used to render the visual image capture aids.

5. The method of claim 1 wherein the visual details of the garment stored within a clothing record comprise at least one photograph of the garment on the mannequin from which accurate color, pattern and other details can be achieved in the rendering of a fitting image.

6. The method of claim 1 wherein the clothing record creation subroutine comprises:
a. in a data capture step, serving a data capture interface to the user client device originating the clothing creation request permitting the entry of clothing details comprising:
i. identifying details of the clothing article;
ii. a clothing size value corresponding to the manufactured size of the clothing article;
iii. a single clothing image being a photo image of the physical clothing article on a standard-sized mannequin corresponding to the clothing size value, captured from the side of the mannequin from a standardized location and in a standardized scale; and
iv. visual details of the garment;
b. receiving completed and transmitted clothing details from the user client device at the server;
c. using the single clothing image, generating a clothing overlay model being a mathematical model by which a three-dimensional rendering of the clothing article positioned on a standard body size can be created; and
d. creating and storing a clothing record in the wearer database corresponding to the captured clothing details and the generated clothing overlay model.

7. The method of claim 6 wherein:
a. the user client device includes a camera;
b. the data capture interface served in the data capture step permits the use of said camera for live capture of the single clothing image; and
c. the data capture interface provides visual image capture aids to coach the appropriate positioning of the camera for the proper selection of the standardized location for capture of said single clothing image in the desired standardized scale.

8. The method of claim 7 wherein:
a. the clothing details transmitted from the user includes the height of the mannequin on which the clothing article is being photographed; and
b. the height of the mannequin is used to render the visual image capture aids.

9. The method of claim 7 wherein:
a. the clothing details transmitted from the user includes a standard size of the mannequin on which the clothing article is being photographed;
b. the height of the mannequin is determined by the fitting software component from a dataset of heights of standardized mannequin size indicators; and
c. the height of the mannequin is used to render the visual image capture aids.
